(19) United States
(12) Patent Application Publication
(10) Pub. No.: US 2009/0228561 A1
(43) Pub. Date: Sep. 10, 2009

(54) Method and System for Promoting a Website

(76) Inventor: Robert Frank Finkeldey, Scotland Island (AU)

Correspondence Address: FROMMER LAWRENCE & HAUG, 745 FIFTH AVENUE- 10TH FL., NEW YORK, NY, 10151, US

(21) Appl. No.: 12/105,560

(22) Filed: Apr. 18, 2008

(30) Foreign Application Priority Data
Mar. 4, 2008 (AU) 2008201014

(51) Int. Cl. G06F 15/16

(52) U.S. Cl. 709/206; 709/204

(57) ABSTRACT

A system for promoting a website through a user of the website is disclosed. The system includes a data generator for generating data, the data including user identity information for identifying the user. The system also includes a data sender for sending the data to the user for forwarding to one or more persons.

### FIELD OF THE INVENTION

The present invention relates to promotion of a website, and particularly but not exclusively to a method and system of rewarding a user who distributes a website URL.

### BACKGROUND OF THE INVENTION

Websites providing access to commercial services, such as retail or auction websites, are prolific. While internet directories exist for finding these websites, a person will only find the website if they are seeking a particular service. A user is unlikely to know of the service and thus unlikely to search in a directory for a web portal for the service, especially in the case of a excitingly new and unexpected type of service or website.

Referrals to new websites are, in these situations, highly valuable. Potential referrers are usually reluctant to forward details of a website to another person because it can be time consuming and appear too direct or forward which may embarrass the referrer and/or referee.

### SUMMARY OF THE INVENTION

According to a first aspect of the invention there is provided a method of promoting a website through a user of the website, the method comprising the steps of:

generating data, the data comprising user identity information for identifying the user; and

sending the data to the user for forwarding to one or more persons.

The data may comprise a link to another object or resource. The data may comprise a URL and/or a Universal Resource Identifier (URI) and/or a URL for an object or resource. The URI may comprise a domain name. The domain name may be the domain name of the website. The user identity information may form part of a query or fragment part of the URI. In some embodiments the step of sending the data to the user comprises the step of sending an email tag including the URI to the user. The email tag may promote the website. The email tag may include a clickable link to the site. The clickable link may be the URI. The email tag may be arranged for insertion at the end of an email from the user to the one or more persons. In some embodiments the method comprises the step of giving the user the opportunity to edit and/or compose at least part of the email tag. The step of sending an email tag including the URI to the user may comprise the step of sending a web page including the URI to the user. In accordance with some embodiments of the invention, the user may configure an email application to automatically insert the email tag into emails composed by the user.

In some embodiments the method may further comprise the step of receiving a request from one of the one or more persons for the resource. In the embodiments where the data comprises a URI, the step of receiving a request may include the step of receiving the URI from the person. In accordance with some embodiments, where an email tag includes a link, the person may initiate the request by clicking on the clickable link. Alternatively, the person may initiate the request by inserting the URI in an address bar of a world-wide web browser.

In some embodiments, where the method comprises the step of receiving a request from one or more persons, the method may further comprise the step of extracting from the received request the user identifying information. The method may further comprise the step of identifying the user from the user identifying information and recording that the website was promoted to the person by the user.

In some embodiments the method further comprises the step of rewarding the user. The step of rewarding the user may comprise the step of rewarding the user when the one or more persons completes an action. The action may be initiated on the website The action may be initiating an auction on the website. The reward may be one or more of cash, a voucher and/or voucher code, a service, and redeemable reward points.

In some embodiments, where the data comprises a URI, is the method further comprises the step of instructing the user to send the data including the URI. The instruction may include directions to include the URI in an email from the user to the one or more persons. In an alternative embodiment, the instruction includes directions to include the URI in a SMS to the one or more persons by the user.

According to a second aspect of the invention there is provided a method of promoting a website through a user of the website, the method comprising the steps of:

receiving from the user a request to send information promoting the website to a person; and

sending the information to the person.

In some embodiments the step of sending information may include sending an email to the person. The step of sending the email comprises the step of including a URI and/or a URL to the website. The URI may include user identity information. The URI may be a clickable link.

In some embodiments the method includes rewarding the user. The step of rewarding the user may include rewarding the user when the person completes an action. The action may be initiated on the website.

In some embodiments the method includes the step of giving the user the opportunity to edit and/or compose at least part of the email.

In some embodiments the method comprises the preliminary step of authenticating the user, the process comprising the steps of:

receiving an address of an email account associated with the user;

receiving a device number of a device associated with the user;

sending an email containing authentication information to the email account;

sending different authentication information to the device;

receiving a first message and a second message from the user;

confirming that the first message comprises the authentication information contained in the email; and

confirming that the second message comprises different authentication information sent to the device.

According to a third aspect of the invention there is provided a system for promoting a website through a user of the website, the system comprising:

a data generator for generating data, the data including user identity information for identifying the user; and

a data sender for sending the data to the user for forwarding to one or more persons.

In some embodiments the data generator may be arranged to generate a Universal Resource Identifier (URI) for inclusion in the data. The data generator may be arranged to include the user identity information as a query or fragment part of the URI included in the data. The data generator may include a business rules server.

In some embodiments the data sender includes a web server. In these embodiments the data is sent as web page information. Alternatively, the data is sent as an email by an email server.

In some embodiments the system may further comprise a request receiver for receiving a request from one of the one or more persons for the resource. The request receiver may include a web server. In some embodiments the system may further comprise user identifying information extractor for extracting from the received request the user identifying information. The extractor may include the web server and/or the business rules server. The system may further comprise a database for identifying the user from the user identifying information. The system may comprise a database for recording that the website was promoted to the person through the user.

In some embodiments the method further comprises a user reward subsystem. The user reward subsystem may comprise a database for tracking, issuing and redeeming rewards.

According to a fourth aspect of the invention there is provided a system for promoting a website through a user of the website, the system comprising:

a request receiver for receiving from the user a request to send information promoting the website to a person; and

an information sender for sending the information to the person.

The request receiver may comprise a web server. The information sender may comprise an email server.

In accordance with a fifth aspect, the present invention provides a computer program comprising instructions for controlling a computer to implement a method in accordance with the first aspect of the invention.

In accordance with a sixth aspect, the present invention provides a computer readable medium providing a computer program in accordance with the fifth aspect of the invention.

In accordance with a seventh aspect the invention provides a computer program comprising instructions for controlling a computer to implement a method of the second aspect.

In accordance with an eighth aspect, the invention provides a computer readable medium in accordance with the seventh aspect.

The term “server” in this specification is intended to encompass any combination of hardware and software that performs services for connected clients in part of a client-server architecture. The client and a server may be separate software running on a single piece of hardware or a plurality of connected pieces of hardware.

### BRIEF DESCRIPTION OF DRAWINGS

In order to achieve a better understanding of the nature of the invention embodiments of a method and process for promoting a website through a user of the website will now be described, by way of example only, with reference to the accompanying figures in which:

FIG. 1 shows a flow diagram of one embodiment of a method for promoting a website;

FIG. 2 shows one embodiment of a system for promoting a website;

FIG. 3 shows another embodiment of a method of promoting a website;

FIG. 4 shows a screen shot of a web page according to one embodiment of the system and method, the web page providing an email tag to the user;

FIG. 5 shows a web page of one embodiment of the method and system for promoting a website, the web page being arranged for the user to request an email promoting the website to be sent to another person;

FIG. 6 shows a screen shot of a web page according to the system and method for promoting a website, the web page being arranged to redeem a reward or voucher;

FIG. 7 shows a screen shot of a web page of one embodiment of a system and method of promoting a website, the web page being arranged to view the status of promotional emails sent to other persons;

FIG. 8 is a screen shot of one embodiment of a web page allowing a potential user to register for the website by pressing a register now button;

FIGS. 9-12 show screen shots of different fragments of a web page for a method and system for promoting a website, the page being arranged to allow the prospective user to enter information during an authentication process during registrations;

FIG. 13 shows a screen shot of a web page according to one embodiment of the method and system for promoting a website, the web page being arranged to re-enter validation or authentication information given to the user during the registration process; and

FIG. 14 shows a screen shot of a web page of one embodiment of the system and method of promoting a website, the page being arranged to allow the user to create a password for future access to the website.

### DETAILED DESCRIPTION OF EMBODIMENTS OF THE INVENTION

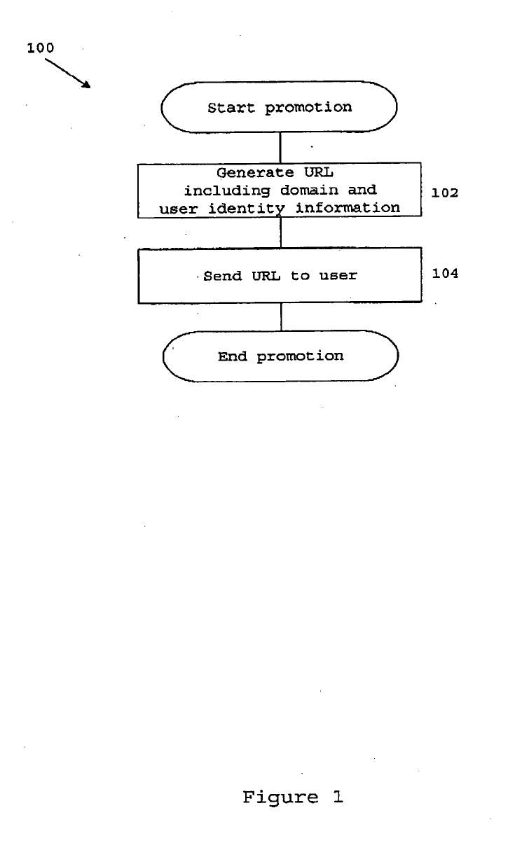

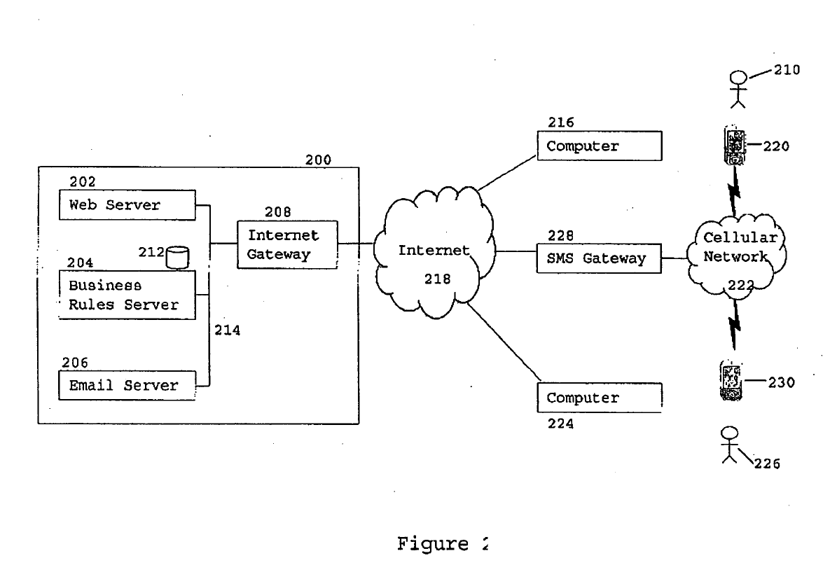

A flow diagram representing one embodiment of a method of promoting a website through a user of the website is shown in FIG. 1 and is generally indicated by the numeral 100. An embodiment of a corresponding system 200 is shown in FIG. 2. The method 100 is implemented at least in part as computer software running on servers 202, 204 and 206 of the system 200. Generally, the software may be a propriety version of the open source DRUPAL content management platform with extra components coded using the PHP programming language. The servers 202, 204 and 206 are connected by a local area network 214, including a switched Ethernet data link layer supporting Internet Protocol (IP) as a network layer protocol. Also included in the system 200 is an internet gateway 208 such as a router, DSL Modem or equivalent connected to the internet 218 for the system to communicate with a computer 216 of the user 210.

The website may be any website that would benefit from promotion. One type of website that would benefit from promotion is an online market place for trades and services, such as the whocando.com.au website. This website provides a method of providing a tradesman or service provider. The user 210 posts on the website a job that needs doing, that is a service request. Tradesmen and service providers can then view the posted job and place a bid for performing the job or providing the service. The tradesmen or service provider can find many such postings and bid on more than one posting. The person 210 can then select one of the bids which is then awarded to the associated tradesman or service provider. This market place can operate in several ways. Firstly, the user 210 can define a maximum price for the job, and the bidders, that is the tradesman or service providers, undercut each other. Secondly, a ceiling price may be set by the user 210. Thirdly, no ceiling may be set by the user 210, and in this case the system operates similarly to a quotation process or a tender system. In all these cases, the user 210 can reject all bids or select any bid. For services there are bid selection criteria other than price which are important, such as the certificates held by the tradesman service provider, their reputation, awards for their work or any other relevant factors. It will be appreciated that this system is unique in that is a market place for trades and services, however it can also be adapted for products, such as for the bulk supply of office materials. The services may include, for example, the provision of a design for a building extension, the renovation of a bathroom, the cleaning of a gutter, the splitting of fire wood and household chores.

The system 200 includes a data generator 204 which in this embodiment is a business rules server 204 including a database 212. The business rules server 204 generates data, in this case a Universal Resource Identifier (URI) for an object or resource, such as a web page or domain of the promoted website, including user identity information for identifying the user as shown in step 102. The database 212 includes the identity and registration details of all the existing users, such as 210, of the system 200. The user identity information is included in the URI as a query. An example URI generated by the server 204 is:

https://www.whocando.com.au/?q=user/register/referer/a/54/535

The above URI includes the domain name www.whocando.com.au of the website WhoCanDo. The user identity information is the coded user identity a/54/535. It forms part of the query component of the URI after the symbols ?q. The user identity information a/54/535 is stored in the database 212 for future use. The user's identity information is coded for the user's 210 privacy. In this case, the user identity information corresponds to the registered user “Justin Blows”. In some embodiments, the URI may be replaced with a URL or URN.

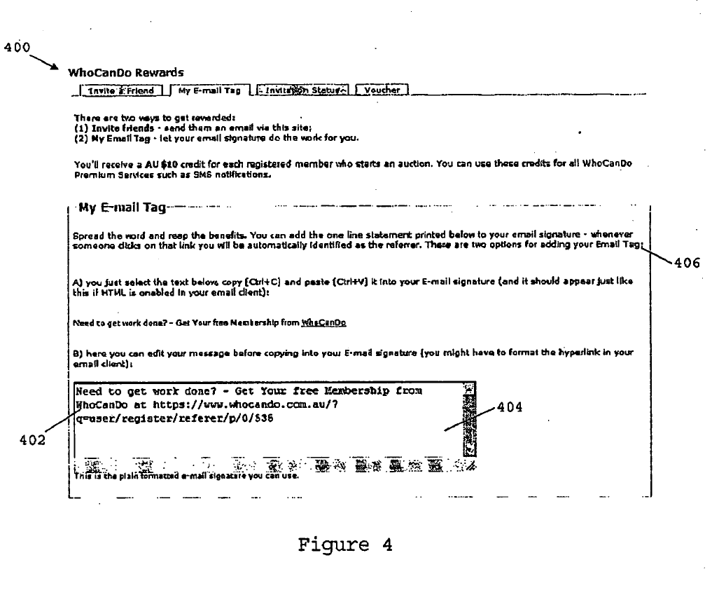

The system 200 includes a data sender, in this example embodiment being in the form of a web server 202. The web server 202 receives from the business rules server 204 the URI. As indicated by step 104 in FIG. 1, the web server 202 sends the URI to the user's 210 computer 216 as part of web page information from which web page 400 is rendered. An example web page 400 including the URI 402 is shown in FIG. 4. The web page information includes HTML and cascading style sheets, possibly incorporating JAVA code. In this embodiment, the internet connection between the user's 210 computer 216 and the system 200 uses a cryptographic protocol such as a Secure Socket Layer, preferably with 128 bit encryption, or Transport Layer Security (TLS). The web page information is rendered by a web browser on the user's 210 computer 216 The URI 402 is formatted as a clickable link to the WhoCanDo website, and is embedded within the following text:
Need to get work done?—Get Your free membership from WhoCanDo at https://www.whocando.com.au/?q=user/register/referer/a/54/535

The text is arranged for insertion at the end of an email, that is as an email tag or signature, from the user to the one or more nominated or other persons 226. These nominated or other persons 226 are generally acquaintances of the user, and thus the promotion takes the quality of a personal referral. The text can be cut [Ctrl+C] from a text box 404 and then pasted [Ctrl+V] into a window of an email application. Before cutting, the text in the text box 404 can be composed or edited. The user 210 may configure an email application running on their computer 216 or their mobile handheld device 220 connected to a wireless/cellular network 222 to automatically insert the email tag into emails composed by the user 210. The email tag passively promotes the website in contrast to sending an email with the sole purpose of promoting the website. In this embodiment, the web page 400 contains instructions 406 the user to include the text in text box 404 in an email from the user 210 to the one or more persons 226. In alternative embodiments, the instruction may direct the user 210 to include the URI in a SMS to a mobile handheld device 230 of the one or more persons 226. The URI does not need to be visible to the user provided that it is included in the clickable link.

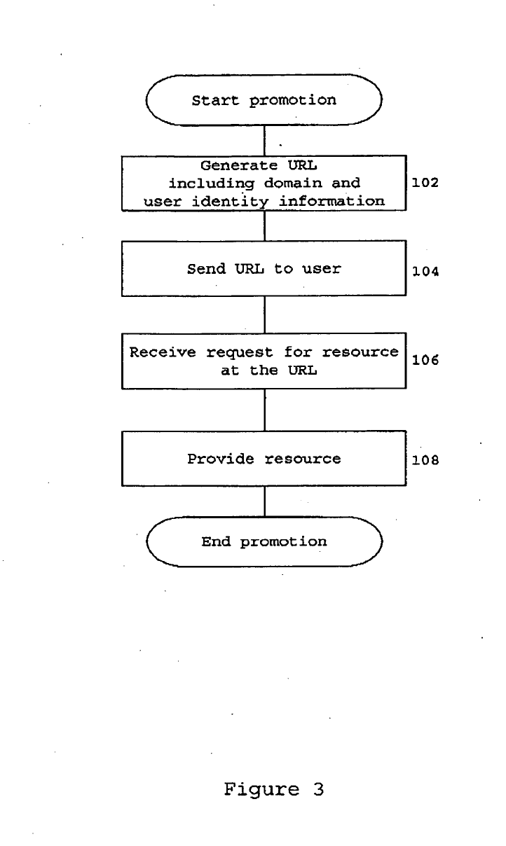

In some embodiments of the method as shown in FIG. 3, the other person 226 clicks on the clickable link embedded in an email received from the user 210 on their computer 224. This sends a request for the resource at the URI 402 which is received by the web server 202 at step 106. The web server 202 extracts the user identity information and sends it to the business rules server 204, the server 204 recording in a database 212 that the nominated person 226 was referred to the website by the user 210. The web server 202 then serves the web page pointed at by the URI to the nominated person's computer 224 at step 108. The nominated person 226 is thus connected to the promoted website. Alternatively, the person 226 may initiate the request by inserting the URI in an address bar of a world-wide web browser.

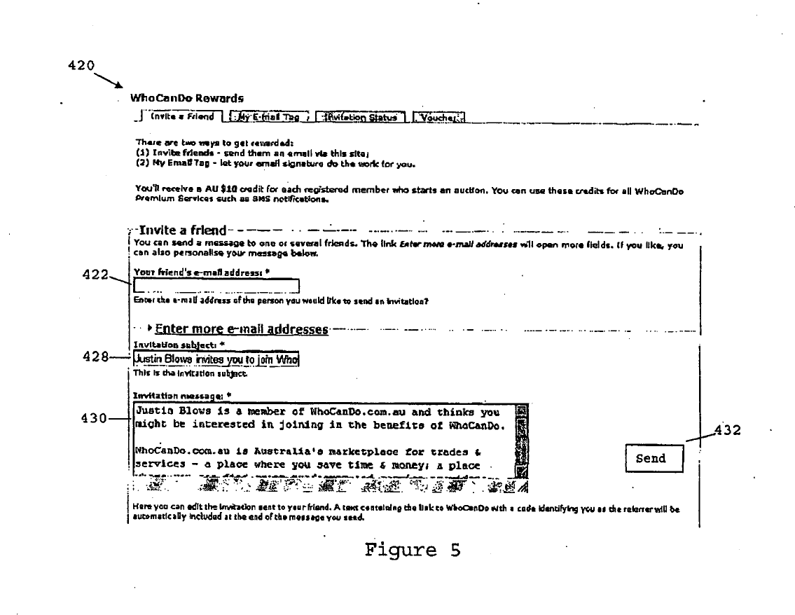

The system 200 can also send an email to the person 226 on request by the user 210. This is done through a web page such as 420 shown in FIG. 5. The user 210 enters the nominated person's 226 email address into the text box 422. The user 210 then enters an invitation subject line for the email into text box 428. Invitation text for inclusion in the email is auto generated and displayed for editing, if desired by the user 210, in text box 430. In this embodiment, the text in text box 430 is:
Justin Blows is a member of WhoCanDo.com.au and thinks you might be interested in joining in the benefits of WhoCanDo.
WhoCanDo.com.au is Australia's marketplace for trades & services—a place where you save time & money; a place where you can find great tradesmen and service providers and where you can find new business and customers.
To access your FREE membership of WhoCanDo, please click on the link below.
Your WhoCanDo team
auction jobs online
Need to get work done?—Get Your free Membership from WhoCanDo at https://www.whocando.com.au/?q=user/register/referer/a/54/535 today!

The text includes the clickable link URI to the website, including user identity information. A person will be taken to the website if they click on the clickable link. The text in text box 430 is sent to the email address 422 on the user 210 pressing the ‘send’ button 432 on the web page 420.

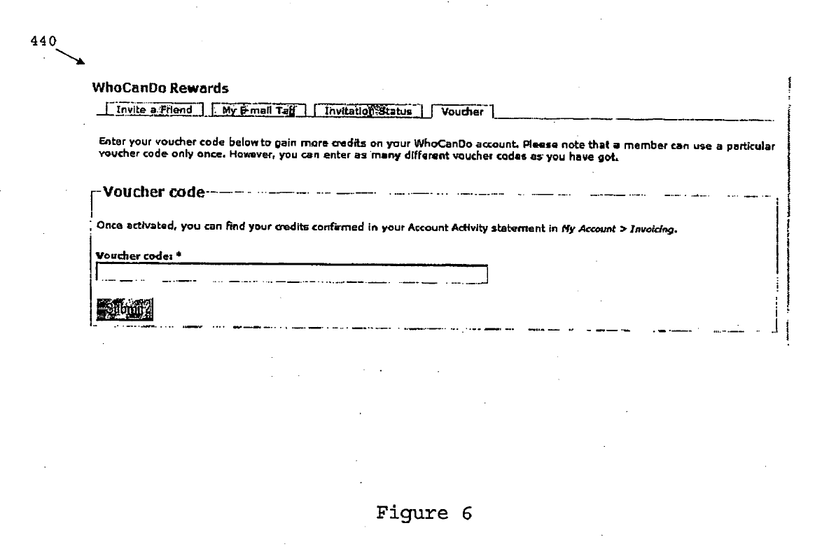

If the nominated person 226 uses the website the user 210 is rewarded. In this embodiment, for example, the user 210 is rewarded for the nominated person 226 posting a job or service requirement on the website. The reward may be in the form of a voucher or voucher code redeemable at a web page such as 440 shown in FIG. 6. Rewarding the user, however, may include rewarding the user when the person 226 completes any suitable action. The action may be initiated on the website, but it may be a manual process. The system includes a user reward subsystem, including the database 212 and business rules server 204 for tracking, issuing and redeeming rewards.

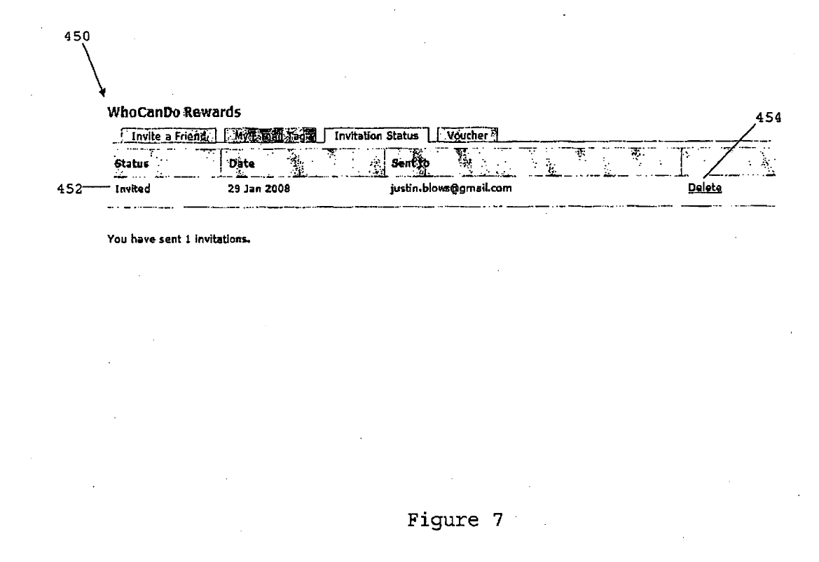

The system 200 can provide a web page, such as 450 in FIG. 7, which allow the user 210 to view the status of the invitations sent by the system 200 on the user's 210 request. An Invitation 452 can be deleted by pressing a delete link 454.

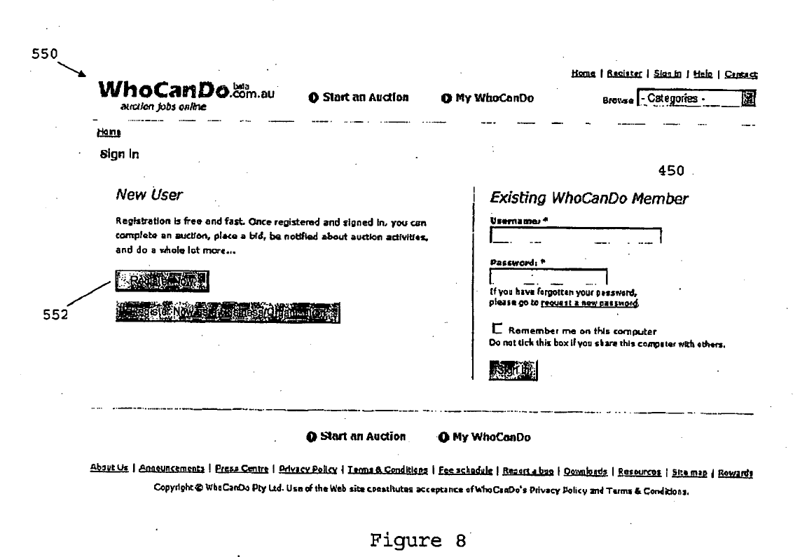

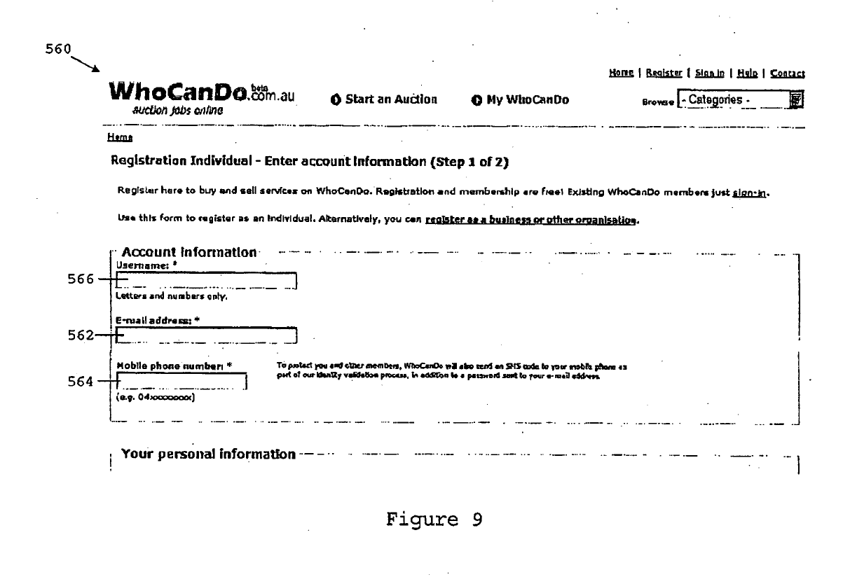

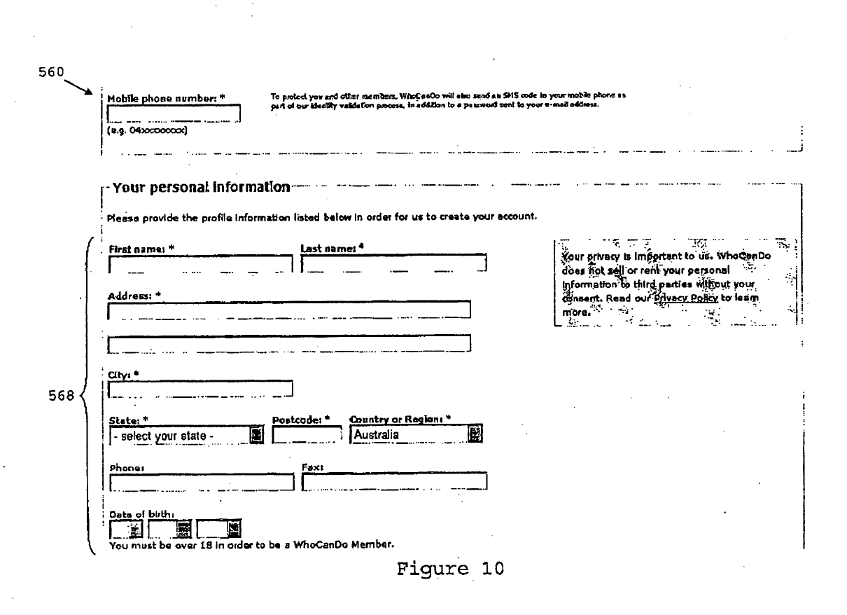

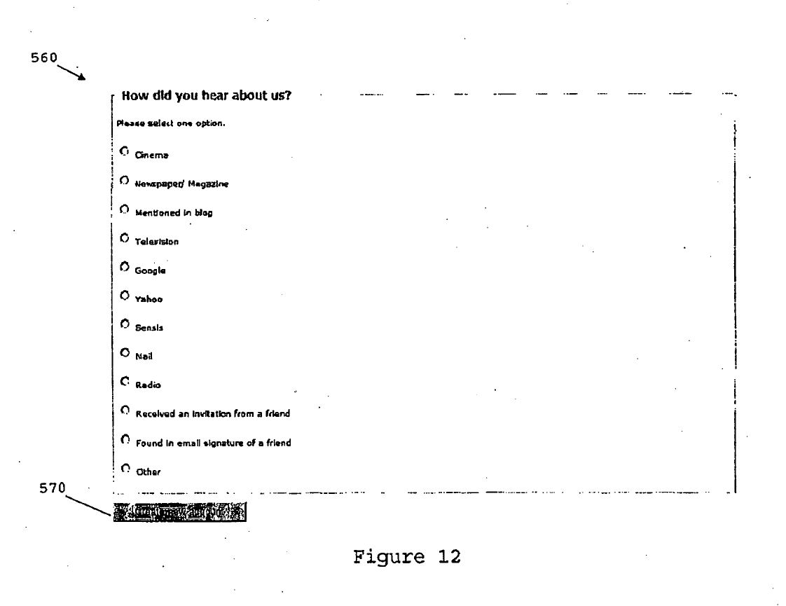

The system 200 also implements a process for authenticating the user 210 during registration for the website, that is while the user 210 is still a prospective user 210. As shown in FIG. 8, this process is generally initiated by the prospective user 210 pressing a “register now” button 552 on a “sign in” page 550. On pressing the “register now” button 552, the system 200 provides a web page such as that shown in FIGS. 9-12 indicated by numeral 560. The web page 560 is arranged for the prospective user 210 to enter their email address and mobile/cellular telephone number in text boxes 562 and 564 respectively. A text box 566 is also provided to enter a user name desired by the user for use on the website. Personal, postal and contact details can also be entered at 568. The user 210 can then press a “create new account” button 570 which sends the details entered into the web page to the web server 202. The system 200 receives the email address 562 and the mobile phone number 564 that is associated with the prospective user 210. The system 200 generates authentication information in the form of an authentication code and sends the authentication code to the email address 562. The system 200 also sends another authentication code to the user's mobile phone 220 having the supplied phone number 564. The email address 562 is associated with the user and is preferably the email address commonly used by the user. The system 200 also can use this email address to send various future alerts and messages to the user 210. It will be appreciated that the mobile phone 220 may be an alternative device such as any suitable mobile handheld device. Example devices include the BLACKBERRY or a pager. The another authentication code sent to the mobile phone 220 or other device is in this embodiment sent over a short message service (SMS). The system initiates a request with an SMS gateway 228 for the SMS to be sent to the device 220.

In some embodiments, the process of authentication also includes the step of confirming that the mobile phone number corresponds to a mobile phone 220 that has been issued to a predetermined geographical region, such as Australia This may be achieved by checking a leading set of digits of the device or telephone number entered by the user 210 at text box 564. This is useful in limiting the service provided by the website to a particular predetermined geographical region. For example, the system 200 may check that the number 564 has ten digits and starts with 04, which is consistent with an Australian mobile number.

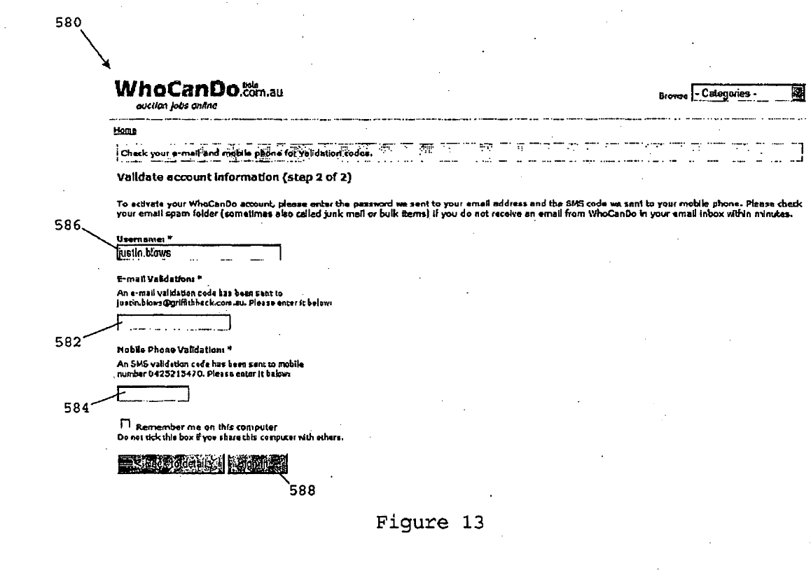

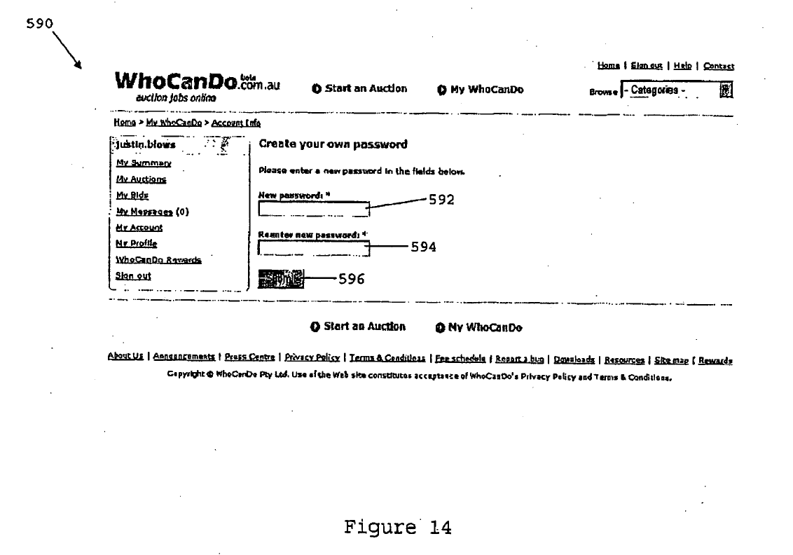

The system 200 sends an authentication or validation code to the email address 562 and another authentication code to the mobile number 564. The user 210 then retrieves the authentication code from the email account having the associated address 562, and the another authentication code from the mobile phone 220. At web page 580 provided by the system 200 shown in FIG. 13, the user 510 enters a message, which in this embodiment comprises a character string corresponding to each of the authentication codes in text boxes 582 and 584. The web page 580 also has a text box 586 for the user 210 to enter the user name previously entered at text box 566. The user 210 then presses the “sign in” button 588 which sends the authentication code and the another authentication code to the web server 202. The system 200 receives the first character string and the second character string entered by the prospective user 210 and then confirms that the first character string is the authentication code sent in the email, and that the second character string is the another authentication code sent to the device or mobile phone. If these are confirmed, the system has authenticated the user 210. Otherwise the user is not authenticated and the user is not registered. After the user is authenticated, the system may provide a web page 590 which allows the user to create a password by entering it into text box 592 (and then again for confirmation in text box 594) and then pressing the submit button 596. This completes the registration process.

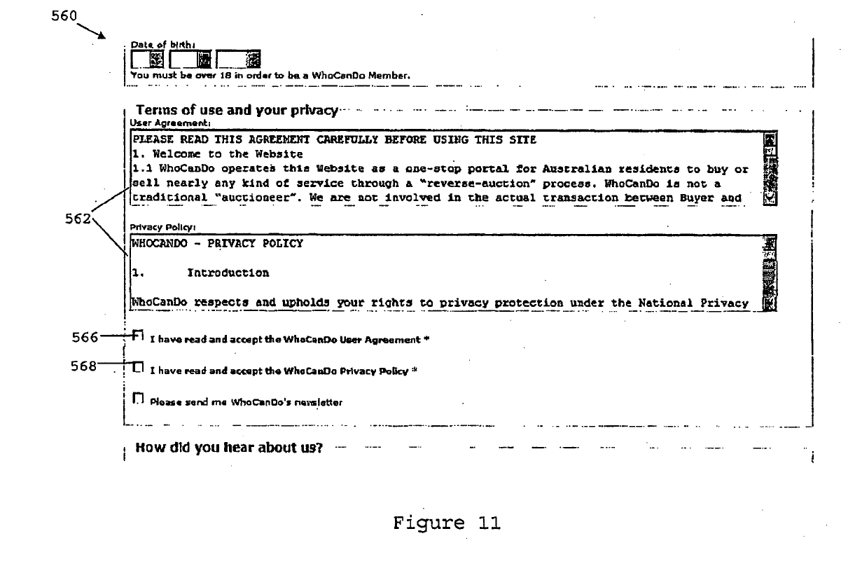

In some embodiments of the authentication process the user may be required to view a web page displaying terms of use and the privacy policy of the website, such as displayed at 562 in FIG. 11. The user 210 can confirm that the privacy policy and terms of use are accepted by checking boxes such as 566 and 568 on web page 560.

Now that preferred embodiments of the invention have been described, it will be appreciated that at least some embodiments have some of the following advantages:
Rewarding a user of a website for a referral to the website encourages referrals and results in the website's address being widely disseminated by users of the website.
The website is advertised to persons that may not be reachable through other methods of promotion or advertising
The personal touch of the other or nominated person receiving an email or email tag by a user known to them (possibly a friend) is more likely to result in the nominated person using the website than if an impersonal advertising method was employed.
The email tag is a relatively ‘unobtrusive’ method of advertising or promoting the website, and the user is thus more likely to promote the website than for more direct and possibly offensive referral means.
The email tag is automatically sent each time the user sends an email, without requiring the user's involvement after the initial configuration of the tag and instructing the users email program to automatically insert the tag.
Instead of a single channel for authentication/registration, such as email, two channels including email and SMS to a handheld mobile device is required for authentication. While it is easy to create additional and/or fraudulent email addresses using Hotmail™, for example, it is much more difficult to create additional or fraudulent mobile phone numbers. Thus it is much more likely that there will be a one to one correspondence between real persons and registered users. This extra security is especially important in websites such as the embodiments described above which include a reward program, where fraudulent identities using fraudulent email accounts can be set up and then used to send spam including URL's including identity information as described above.
During the registration/authentication process both an email address and a phone number is provided to the system which provides two channels of communication to the user via the system and other users of the system which increases the chance of successfully contacting the user.
An email address is provided which can be used as a general communication channel which is very cheap. It can contain more information than sent to the user through a SMS to the mobile phone. However, this system holds a phone number to which SMS's can be sent to for special promotions and advertising campaigns, for example.
The authentication method using both email and SMS is desirable in processes which involves bidding from multiple people. It prevents fraudulent bids from multiply registered identities. It prevents people such as children bidding who do not have a mobile phone.
The phone number is generally traceable to a real person through official or telephone providers records. A telephone number can be used to block undesirable individuals as most users only have a single mobile phone number.
The telephone number can be used as an unique identifier for a person, especially if that person only has a single mobile phone.

In the claims which follow and in the preceding description of the invention, except where the context requires otherwise due to express language or necessary implication, the word “comprises or variations such as comprises” or “comprising” is used in an inclusive sense, i.e. to specify the presence of the stated features but not to preclude the presence or addition of further features in various embodiments of the invention.

It will be appreciated that numerous variations and/or modification may be made to the specific embodiments without departing from the spirit or scope of the invention as broadly described. For example, the SMS gateway may be incorporated in the system. The portable handheld device may be any portable handheld device with an associated telephone number or indeed any SMS capable device. The system may be located on a single physical device such as a single server. The connection between the system and the computer may not be over the internet but some other network such as a local or wide area network or WiFi, WiMax or any other suitable network. The computer and the mobile handheld device may be the same device. The bid may be a quotation. The message sent to the device may be over an equivalent message service to the Short Message Service, for example over a pager service. The data comprising user identity information may be sent in a file over the internet. The present embodiments are, therefore, to be considered in all respects as illustrated and not restrictive.

1. A method of promoting a website through a user of the website, the method comprising the steps of:
generating data, the data comprising user identity information for identifying the user; and
sending the data to the user for forwarding to one or more persons.

2. A method defined by claim 1 wherein the data comprises a Universal Resource Identifier (URI) for an object or resource.

3. A method defined by claim 2 wherein the URI comprises a domain name.

4. A method defined by claim 3 wherein the domain name may be the domain name of the website.

5. A method defined by either claims 3 or 4 wherein the user identity information may form part of a query or fragment part of the URI.

6. A method defined by any one of claims 2 to 5 wherein the step of sending the data to the user includes the step of sending an email tag including the URI to the user.

7. A method defined by claim 6 wherein the email tag includes a clickable link to the site.

8. A method defined by any one of claims 1 to 7 further comprising the step of receiving a request from one of the one or more persons for the resource.

9. A method defined by claim 8 wherein the step of receiving a request may include the step of receiving the URI from the person.

10. A method defined by claim 9 further comprising the step of extracting from the received request the user identifying information.

11. A method defined by claim 10 further including the step of identifying the user from the user identifying information and recording that the website was promoted to the person by the user.

12. A method defined by any one of claims 1 to 11 comprising the step of rewarding the user.

13. A method defined by claim 12 wherein the step of rewarding the user may include the step of rewarding the user when the person completes an action.

14. A method of promoting a website through a user of the website, the method comprising the steps of:
receiving from the user a request to send an email promoting the website to a person; and
sending the email to the person.

15. A method defined by claim 14 wherein the step of sending the email includes the step of including a. URI for and/or hot link to the website.

16. A method defined by claim 15 wherein the URI and/or clickable link may include user identity information.

17. A method defined by any one of claims 13 to 16 including rewarding the user.

18. A system for promoting a website through a user of the website, the system comprising:
a data generator for generating data, the data including user identity information for identifying the user; and
a data sender for sending the data to the user for forwarding to one or more persons.

19. A system for promoting a website through a user of the website, the system comprising:
a request receiver for receiving from the user a request to send an email promoting the website to a person; and
an email sender for sending the email to the person.

20. A computer program comprising instructions for controlling a computer to implement the method of claim 1.

21. A computer readable medium providing the computer program of claim 20.

22. A computer program comprising instructions for controlling a computer to implement the method of claim 14.

23. A computer readable medium providing the computer program of claim 22.

24. A system as herein described with reference to the accompanying figures.

25. A method as herein described with reference to the accompanying figures.
